(19) United States
(12) Patent Application Publication
(10) Pub. No.: US 2017/0230794 A1
(43) Pub. Date: Aug. 10, 2017

(54) WEARABLE DEVICE FOR A CHILD TO COMMUNICATE WITH PARENTS AND FRIENDS

(71) Applicant: Magnasoft Consulting India Private Limited, Bengaluru (IN)

(72) Inventors: Shyam Ramamurthy, Bengaluru (IN); Bobbie H Kalra, Bengaluru (IN)

(21) Appl. No.: 15/257,432

(22) Filed: Sep. 6, 2016

(30) Foreign Application Priority Data
Feb. 5, 2016 (IN) 201641005344

(51) Int. Cl. H04W 4/02; G08B 21/02; H04L 29/08; H04B 1/3827

(52) U.S. Cl. CPC H04W 4/023; H04B 1/385; G08B 21/0258; H04L 67/1046; H04L 67/42

(57) ABSTRACT

A system enabling children for communicating with parent and friend through a wearable device is enclosed. The system includes a memory unit and a processor that executes a set of modules that includes an information exchange module 304, a digit code generation module 306, and a voice message transfer module 308. The information exchange module 304 exchanges and transfers information between the first child wearable device 104 and the second child wearable device 114 when the first child 102 chooses to add the second child 116 within a close proximity, to a contact list of the first child wearable device 104. The digit code generation module 310 generates a random digit code when the first child 102 chooses to add the second child 116 in a remote location, to the contact list of the first child wearable device 104.

### CROSS-REFERENCE TO RELATED APPLICATIONS

This application claims priority to Indian Patent Application number 201641005344 filed on Feb. 16, 2016, the complete disclosure of which, in its entirely, is herein incorporated by reference.

### BACKGROUND

Technical Field

The embodiments herein generally relate to the field of wearable electronic communication devices, and more particularly to a wearable communication device to enable a child to communicate with parents and friends, without using mobile phones.

Description of the Related Art

Safety of our loved ones is a major concern. Nowadays, child and parent communication is very important, especially for school children. Parents are aware of the school timings for their children, the location of the school, and approximately around what time the child will be coming home from school. However, if a child is coming late from school, mostly parents are unaware since there is no form of communication between them. Almost all schools prohibit children from carrying mobile phones to school and the biggest drawback of this is that the child will not be able to contact the parent and vice versa. Studies have shown that when children engage and compete with their peers, they're more likely to stay motivated to achieve goals and targets.

Accordingly, there remains a need for a wearable device for a child to communicate with parents and friends, without using mobile phones.

### SUMMARY

The present disclosure seeks to provide one or more non-transitory computer readable storage mediums storing one or more sequences of instructions, which when executed by one or more processors, causes a first child associated with a first child wearable device to communicate with at least one of (i) a second child associated with a second child wearable device, and (i) a parent mobile device, said method comprising exchanging of information between said first child wearable device and said second child wearable device when said second child wearable device is within a close proximity of said first child wearable device, wherein said first child associated with said first child wearable device may view details of said second child associated with said second child wearable device and choose to add said second child in a contact list of said first child wearable device, generating a random digit code when said second child wearable device in a remote location to said first child wearable device, wherein said second child wearable device receives said random digit code and said second child has a threshold duration to enter said random digit code to acknowledge adding said first child in said contact list of said second child wearable device, and transferring a voice message for said first child to communicate with from said first child wearable device to at least one of (i) said second child wearable device, and (ii) said parent mobile device.

The present disclosure seeks to provide a server enabling a first child associated with a first child wearable device to communicate with at least one of (i) a second child associated with a second child wearable device, and (ii) a parent mobile device, said server comprising a server memory that stores a voice message transfer database and a first set of modules, wherein said voice message transfer database stores contact information of persons associated with said first child wearable device and a server processor that executes said first set of modules. The first set of modules comprising, an information exchange module implemented by said server processor that transfers information between said first child wearable device and said second child wearable device when said second child wearable device is within a close proximity of said first child wearable device, when said first child chooses to add said second child to a contact list of said first child wearable device, a digit code generation module implemented by said server processor that generates a random digit code when, when said first child chooses to add said second child in a remote location to said contact list of said first child wearable device, and a voice message transfer module implemented by said server processor that transfers said voice message from said first child wearable device to at least one of (i) said second child wearable device and (ii) said parent mobile device.

The present disclosure seeks to provide a first child wearable device, wherein said first child wearable device comprising a device database that stores (i) information of all contacts stored in said first child wearable device and (ii) stores said voice messages received by said first child wearable device from at least one of (a) a second child wearable device and (b) a parent mobile device, a voice message viewing module that enables a first child associated with said first child wearable device to view and listen to said voice messages received from at least one of (i) said second child wearable device and (ii) said parent mobile device, a proximity contact updating module that enables said first child to view details of a second child associated with said second child wearable device and choose to add said second child in a contact list of said first child wearable device, when said first child wearable device is located within a close proximity of said second child wearable device, a digit code receiving module that receives a random digit code by said second child associated with said second child wearable device, and said first child has a threshold duration to enter said random digit code to acknowledge adding said second child in said contact list of said first child wearable device and an automatic message deletion module that automatically deletes heard voice messages and unheard voice messages from said first child wearable device within a threshold time period.

Embodiments of the present disclosure substantially eliminate or at least partially address the aforementioned problems in the prior art, and provide a mechanism for authorized registered users to reach out to a person in distress who is requesting for help in a much faster and quicker way.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated using identical numbers.

Embodiments of the present disclosure will now be described, by way of example only, with reference to the following diagrams wherein:

FIG. 1 illustrates a system view of a first child wearable device communicating a message to a parent through a network according to an embodiment herein;

FIG. 2 illustrates an exploded view of the first child wearable device of FIG. 1 according to an embodiment herein;

FIG. 3 illustrates of an exploded view of a server of FIG. 1 according to an embodiment herein;

FIG. 4 illustrates a user interface view of a proximity contact updating module of the first child wearable device of FIG. 1 according to an embodiment herein;

FIG. 5 illustrates a user interface view of a digit code receiving module of the first child wearable device of FIG. 1 according to an embodiment herein;

FIG. 6 illustrates a user interface view of a pedometer module of the first child wearable device of FIG. 1 according to an embodiment herein;

FIG. 7 illustrates a user interface view of a parent mobile device illustrating the status of the first child of FIG. 1 according to an embodiment herein;

FIG. 8 is an interaction diagram illustrating a process of the first child wearable device of FIG. 1 communicating with the parent mobile device of FIG. 7 through the server of FIG. 1 according to an embodiment herein;

FIG. 9 is an interaction diagram illustrating a process of the first child wearable device connecting and communicating with the second child wearable device of FIG. 1 according to an embodiment herein;

FIG. 10 is a flow diagram illustrating a communication between the first child wearable device with the parent mobile device and a second child wearable device of FIG. 1 according to an embodiment herein;

FIG. 11 illustrates an exploded view of the parent mobile device of FIG. 1 according to an embodiment herein; and

FIG. 12 illustrates a schematic diagram of a computer architecture used according to the embodiments herein.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is point.

### DETAILED DESCRIPTION OF EMBODIMENTS

The following detailed description illustrates embodiments of the present disclosure and ways in which they may be implemented. Although some modes of carrying out the present disclosure have been disclosed, those skilled in the art would recognize that other embodiments for carrying out or practicing the present disclosure are also possible.

In one aspect, one or more non-transitory computer readable storage mediums storing one or more sequences of instructions, which when executed by one or more processors, causes a first child associated with a first child wearable device to communicate with at least one of (i) a second child associated with a second child wearable device, and (i) a parent mobile device, said method comprising exchanging of information between said first child wearable device and said second child wearable device when said second child wearable device is within a close proximity of said first child wearable device, wherein said first child associated with said first child wearable device may view details of said second child associated with said second child wearable device and choose to add said second child in a contact list of said first child wearable device, generating a random digit code when said second child wearable device is in a remote location to of said first child wearable device, wherein said second child wearable device receives said random digit code and said second child has a threshold duration to enter said random digit code to acknowledge adding said first child in said contact list of said second child wearable device, and transferring a voice message for said first child to communicate with from said first child wearable device to at least one of (i) said second child wearable device, and (ii) said parent mobile device.

In one embodiment, the one or more non-transitory computer readable storage mediums storing one or more sequences of instructions of claim 1, wherein said voice message may only be transferred from said first child wearable device to said second child wearable device if said second child wearable device contact details are stored in said contact list of said first child wearable device.

In another aspect, a server enabling a first child associated with a first child wearable device to communicate with at least one of (i) a second child associated with a second child wearable device, and (ii) a parent mobile device, said server comprising a server memory that stores a voice message transfer database and a first set of modules, wherein said voice message transfer database stores contact information of persons associated with said first child wearable device and a server processor that executes said first set of modules. The first set of modules comprising, an information exchange module implemented by said server processor that transfers information between said first child wearable device and said second child wearable device when said first child chooses to add said second child within a close proximity, to a contact list of said first child wearable device, a digit code generation module implemented by said server processor that generates a random digit code, when said first child chooses to add said second child in a remote location, to said contact list of said first child wearable device and a voice message transfer module implemented by said server processor that transfers said voice message from said first child wearable device to at least one of (i) said second child wearable device and (ii) said parent mobile device.

In another aspect, the present disclosure seeks to provide a first child wearable device, wherein said first child wearable device comprising a device database that stores (i) information of all contacts stored in said first child wearable device and (ii) stores said voice messages received by said first child wearable device from at least one of (a) a second child wearable device and (b) a parent mobile device, a voice message viewing module that enables a first child associated with said first child wearable device to view and listen to said voice messages received from at least one of (i) said second child wearable device and (ii) said parent mobile device, a proximity contact updating module that enables said first child to view details of a second child associated with said second child wearable device and choose to add said second child in a contact list of said first child wearable device, when said first child wearable device is located within a close proximity of said second child wearable device, a digit code receiving module that receives a random digit code by said second child associated with said second child wearable device, and said first child has a threshold duration to enter said random digit code to acknowledge adding said second child in said contact list of said first child wearable device and an automatic message deletion module that automatically deletes heard voice messages and unheard voice messages from said first child wearable device within a threshold time period.

In one embodiment, the first child wearable device of claim 4, further comprising a profile presentation module that presents a contact stored in said contact list of said first child wearable device by always showing a profile photo of said contact and at least one of (i) a name of said contact and (ii) a contact number of said contact.

In another embodiment, the first child wearable device of claim 4, further comprising a pedometer module that updates a number of steps taken by said first child to a parent associated with said parent mobile device and if said first child is a pedometer champion, then said profile photo of said first child is embellished with a championship batch.

In another embodiment, the first child wearable device of claim 6, wherein said championship batch embellished on said profile photo of said first child is viewed by at least one of (i) children in said contact list of said first child wearable device and (ii) other children registered within a server.

In another embodiment, the first child wearable device of claim 4, wherein said server comprising a server memory that stores a voice message transfer database and a first set of modules, wherein said voice message transfer database stores contact information of persons associated with said first child wearable device and a server processor that executes said first set of modules. The first set of modules comprises an information exchange module implemented by said server processor that transfers information between said first child wearable device and said second child wearable device when said second child wearable device is within a close proximity of said first child wearable device, when said first child chooses to add said second child to a contact list of said first child wearable device, a digit code generation module implemented by said server processor that generates a random digit code when said second child wearable device is not within said close proximity of said first child wearable device, when said first child chooses to add said second child to said contact list of said first child wearable device, and a voice message transfer module implemented by said server processor that transfers a voice message from said first child wearable device to at least one of (i) said second child wearable device and (ii) said parent mobile device.

In another embodiment, the first child wearable device of claim 5, wherein said voice message is only transferred from said first child wearable device to said second child wearable device if said second child wearable device contact details are stored in said contact list of said first child wearable device.

### DETAILED DESCRIPTION OF THE DRAWINGS

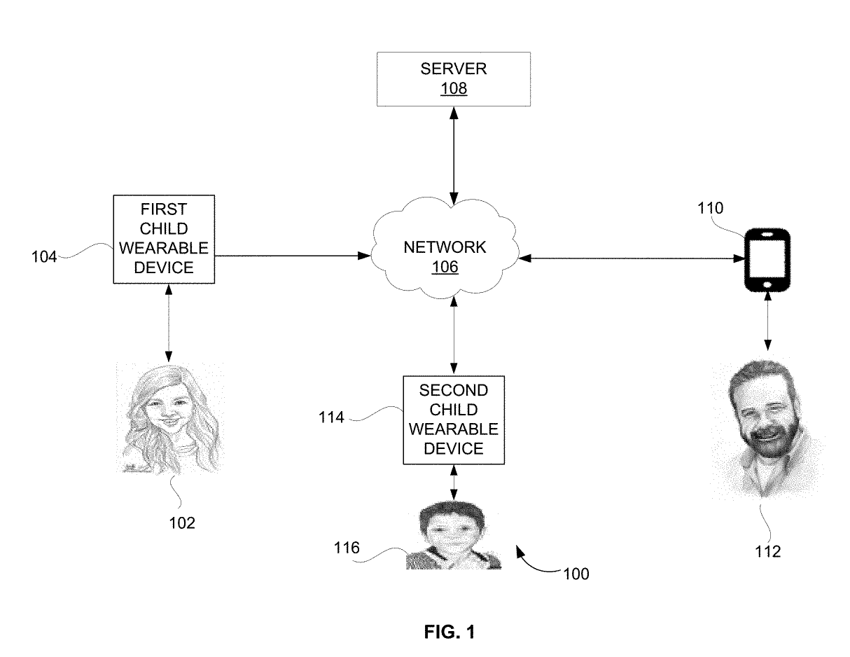

FIG. 1 illustrates a system view 100 of a first child wearable device 104 communicating a message to a parent 112 through a network 106 according to an embodiment herein. The system view 100 includes a first child 102, a first child wearable device 104, a network 106, a server 108, a parent mobile device 110, a parent 112, a second child wearable device 114, and a second child 116. In an emergency situation, if the first child 102 wishes to contact his/her parent 112, then the first child 102 may browse through the contact list of the first child wearable device 104, select the parent 112 contact, then place a voice message. In one embodiment, the voice message can be recorded up till a maximum of 8 seconds, where the first child 102 records a message to the parent 112. For example, the first child 102 may send a voice message to the parent 112 stating that he/she will be coming home late today since they have to stay back for a football match. After selecting the parent 112 from the contact list, the first child 102 clicks on the voice message icon on the screen of the first child wearable device 104, and records the voice message to be send.

In one embodiment, the first child 102 may send another voice message along with the previous voice message. The network 106 transfers the recorded voice message to the server 108. The parent mobile device 110 receives the first child 102 voice message and then to the first child wearable device 104, again by sending a voice message.

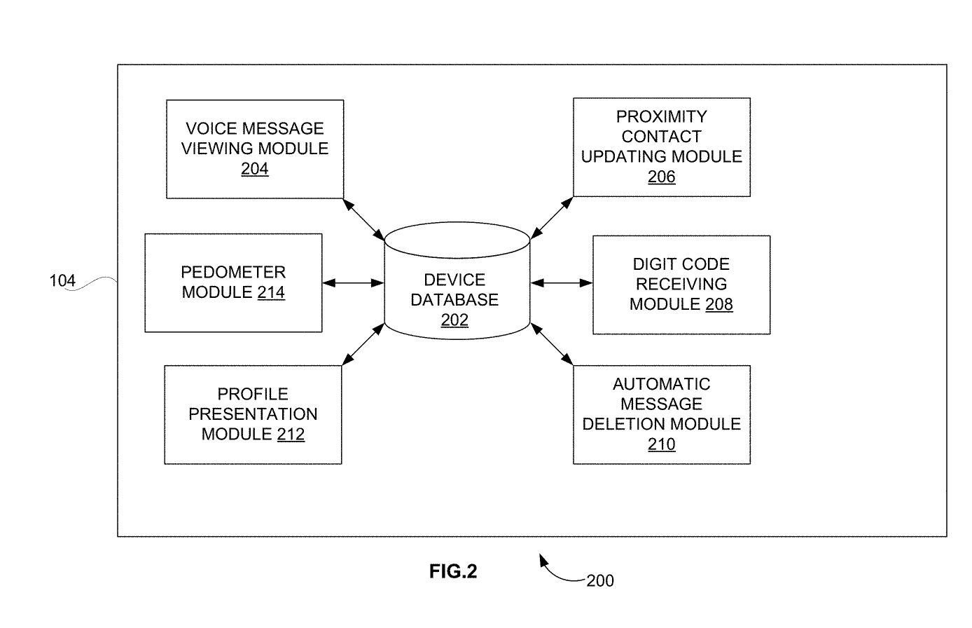

FIG. 2 illustrates an exploded view 200 of the first child wearable device 104 of FIG. 1 according to an embodiment herein. The exploded view 200 includes a device database 202, a voice message viewing module 204, a proximity contact updating module 206, a digit code receiving module 208, an automatic message deletion module 210, a profile presentation module 212, and a pedometer module 214. In one embodiment, the device database 202 interacts with the voice message viewing module 204, the proximity contact updating module 206, the digit code receiving module 208, the automatic message deletion module 210, the profile presentation module 212, and the pedometer module 214. The device database 202 stores the information of all the contacts stored in the first child wearable device 104 and stores the voice messages received by the first child wearable device 104 from at least one of (i) the second child wearable device 114 and (ii) the parent mobile device 110.

In one embodiment, the voice message viewing module 204 enables the first child 102 associated with the first child wearable device 104 to view and listen to the voice messages received and stored in the device database 202 from at least one of (i) the second child wearable device 114 and (ii) the parent mobile device 110. The proximity contact updating module 204 enables the first child 102 to view details of the second child 116 associated with the second child wearable device 114 and choose to add the second child 116 in a contact list of the first child wearable device 104, when the first child wearable device 104 is located within a close proximity of the second child wearable device 114. The digit code receiving module 208 receives a random digit code (of 4 numbers) from the second child 116 associated with the second child wearable device 114 and the first child 102 has a threshold duration of five minutes to enter the random digit code to acknowledge the second child 116 in the contact list of the first child wearable device 104.

The automatic message deletion module 210 automatically deletes old messages from the first child wearable device 104 within a very short time span and the child 102 and the second child 116 does not have to hesitate and waste time in trying to manually delete them. In one embodiment, unheard voice messages by the first child 102 get automatically deleted within seventy two hours of the time that they were received and heard voice messages by the first child 102 get manually deleted within forty eight hours of the receiving time.

In another embodiment, the profile presentation module 212 the contact stored in the contact list of the first child wearable device 104 by always showing a profile photo of the contact and at least one of (i) a name of the contact and (ii) a contact number of the contact. The pedometer module 214 updates a number of steps taken by the first child 102 to the parent 112 associated with the parent mobile device 110 and if the first child 102 is a pedometer champion, then the profile photo of the first child 102 is embellished with a championship badge. The championship badge may be viewed by at least one of (i) children in the contact list of the first child wearable device 104 and (ii) other children registered within the server, whom need not be in the contact list of the first child wearable device 104.

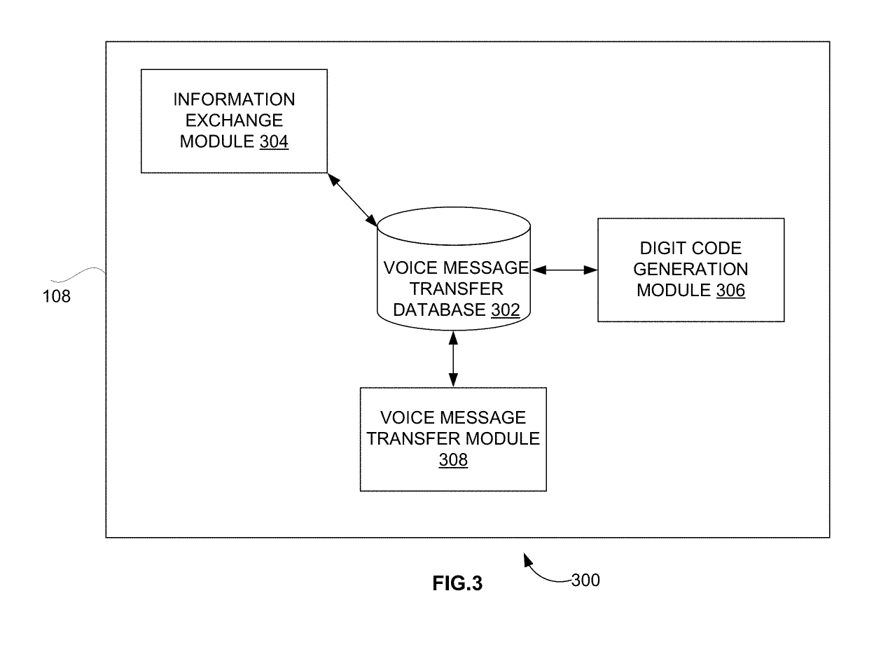

FIG. 3 illustrates of an exploded view 300 of the server 108 of FIG. 1 according to an embodiment herein. The exploded view 300 includes a voice message transfer database 302, an information exchange module 304, a digit code generation module 306, and a voice message transfer module 308. In one embodiment, the voice message transfer database 302 interacts with, the information exchange module 304, the digit code generation module 306, and the voice message transfer module 308. The voice message transfer database 302 stores contact information of persons associated with the first child wearable device 104.

In one embodiment, the information exchange module 304 transfers information between the first child wearable device 104 and the second child wearable device 114 when the first child 102 chooses to add the second child 116 within a close proximity to a contact list of the first child wearable device 104. A close proximity could mean that the first child 102 and the second child 116 live in the same apartment complex, are currently in the same building. This enables details to get transferred between the first child wearable device 104 and the second child wearable device 114.

In another embodiment, the digit code generation module 306 generates a random digit code (of 4 digits) when the first child 102 chooses to add the second child 116 in a remote location to the contact list of the first child wearable device 104. Remote location means that the second child 116 is not in physical proximity with the first child 102, for the first child wearable device 104 and the second child wearable device 114 to exchange information using proximity technologies (like Bluetooth/NFC). For example in another building, another part of the town/city or in yet another city altogether. The first child 102 then has five minute duration to enter the random digit code to acknowledge adding the second child 116 to the contact list of the first child wearable device 104. The voice message transfer module 308 enables transfer of the voice message from the first child wearable device 104 to at least one of (i) the second child wearable device 116 or (ii) the parent mobile device 110.

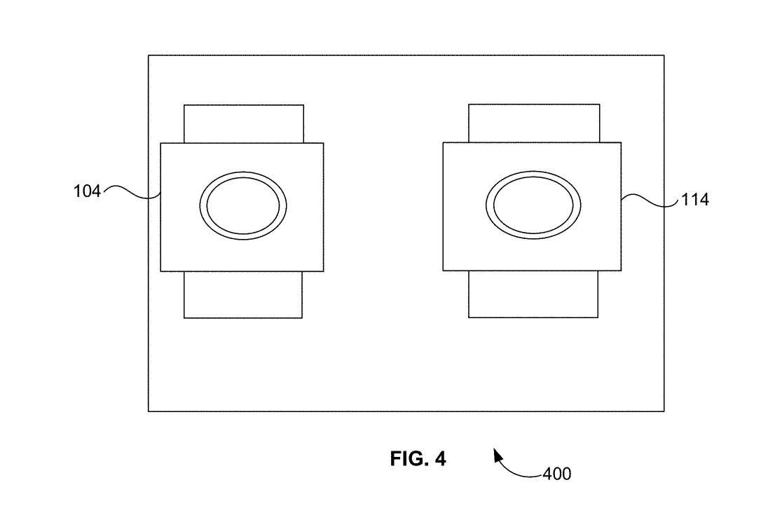

FIG. 4 illustrates a user interface view 400 of a proximity contact updating module 206 of the first child wearable device 104 of FIG. 1 according to an embodiment herein. The first child wearable device 104 has the ability to add other wearable devices registered within the server by the concept of tapping each device, where NFC is employed for secure connection between the two devices. In one embodiment, since the first child wearable device 104 and the second child wearable device 114 are in close proximity to each other, once the both are tapped, contact information is automatically exchanged between the both of them. The first child 102 associated with the first child wearable device 104 user may view the contact information of the second child 116 associated with the second child wearable device 114, which consists at least of (i) a profile picture and (ii) a name, and then decide whether to add the second child 116 user to the contact list of the first child wearable device 104. In another embodiment, the first child wearable device 104 will continuously keep on scanning for nearby devices and will keep on updating the first child 102.

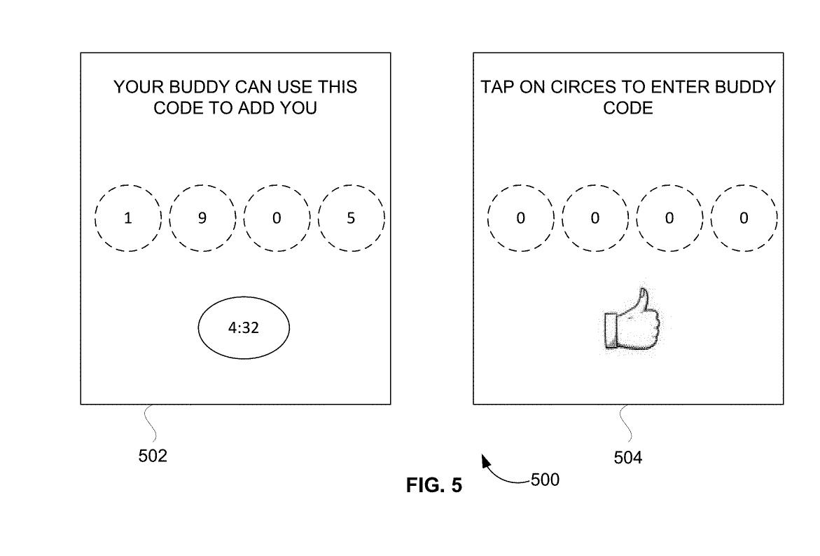

FIG. 5 illustrates a user interface view 500 of a digit code receiving module 208 of the first child wearable device 104 of FIG. 1 according to an embodiment herein. The first child 102 may choose to add a new contact to any registered person within the server 108 in any other remote city. In one embodiment, when the first child 102 selects the friend or contact to be added, then the server 108 automatically generates a four digit random code which will in turn be send to the second child wearable device 114. The second child 116 will receive an immediate message that a friend request has been send from the first child wearable device 104 and in order to acknowledge the request, he/she must enter the four digit code. Then the first child 102 will get intimated that he/she has accepted the request. In another embodiment, the second child 116 has only up till five minutes to either accept or reject the friend request. If the second child 116 does not respond within that particular time period, then the request will get cancelled, however the first child 102 has an option to re-send the friend request once again.

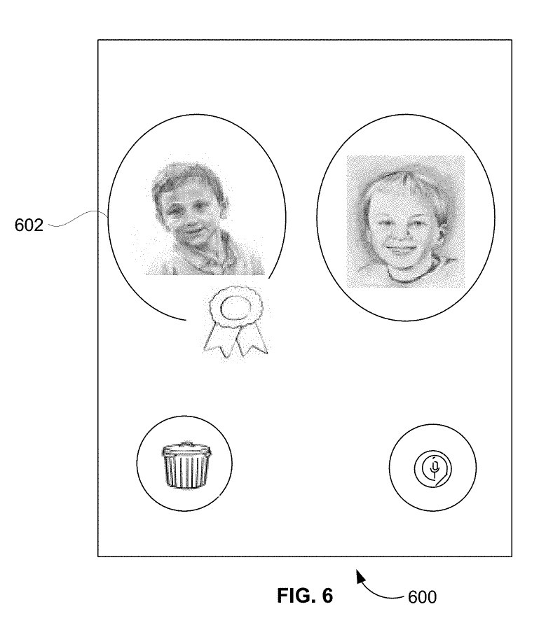

FIG. 6 illustrates a user interface view 600 of the pedometer module 214 of the first child wearable device 104 of FIG. 1 according to an embodiment herein. The user interface view 600 displays the first child 102 contact picture as a pedometer champion. The pedometer module 214 updates the number of steps taken by the first child 102, and the first child 102 is awarded gold stars glorifying his/her achievement. In one embodiment, when the first child 102 scores seven gold starts in a row, then the first child wearable device 104 shows the pedometer champion photo 602 visible on his/her profile. In another embodiment, other children registered within the server 108 may be able to view the pedometer champion photo 602 of the first child 102, and the first child 102 will be more well known as his/her achievement is shared.

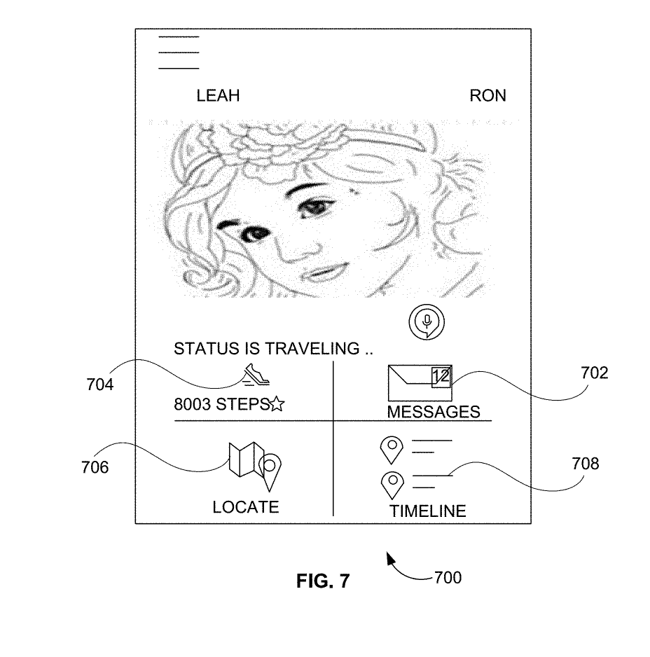

FIG. 7 illustrates a user interface view 700 of a parent mobile device 110 illustrating the status of the first child 102 of FIG. 1 according to an embodiment herein. The user interface view 700 of the parent mobile device 110 includes a messages option 702, a steps option 704, a locate option 706, and a timeline option 708. When the parent 112 clicks on the messages option 702, then he/she may view the details of all the messages send by the first child 102 along with the timings. In one embodiment, if there are any unheard messages, then the parent 112 can immediately view them and try to contact the first child wearable device 104. In the steps option 704, the parent 112 can view the number of steps taken by the child which is determined by the pedometer module 208. In the locate option 706, the parent 112 may view the exact location of the child 102. In another embodiment, the first child 102 location updates periodically and the parent 112 is well aware of current location of the first child 102 at that particular point of time. The timeline option 708, displays to the parent 112 the details of the places where the first child 102 was during the day and at what time he was at that particular place.

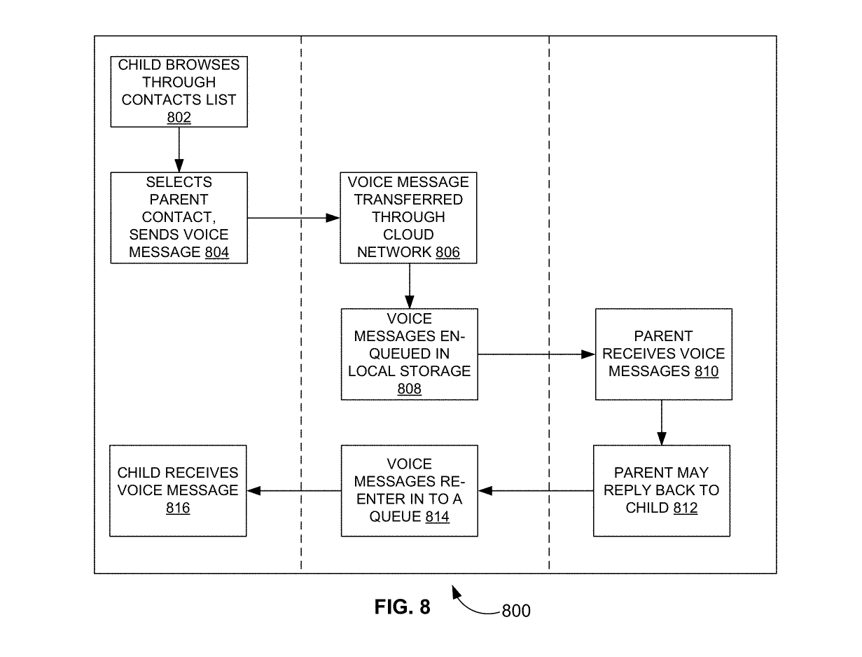

FIG. 8 is an interaction diagram 800 illustrating a process of the first child wearable device 104 of FIG. 1 communicating with the parent mobile device 110 of FIG. 7 through the server 108 of FIG. 1 according to an embodiment herein. At step 802, the first child 102 browses through the first child wearable device 104 contact list to find the details of his/her parent mobile device 110. At step 804, the first child 102 selects the parent 112 contact and sends am eight second voice message. In one embodiment, the child 102 may place multiple voice messages to the parent mobile device 110 one after the other. At step 806, the server 108 assists in transferring the voice message through the network 106. At step 808, the voice messages are automatically downloaded and en-queued in the local storage of the first child wearable device 104. In one embodiment, if the first child 102 sends many voice messages at once, then all the voice messages are assembled one after the other in the queue, and are send to the parent mobile device 110 one after the other depending on the order in which they have arrived.

At step 810, the parent 112 receives the voice message. At step 812, the parent 112 may reply back to the first child 102 if he/she feels it is necessary. In another embodiment, the parent 112 voice message can also not exceed more than eight seconds, but the parent 112 may send multiple voice messages at once. At step 814, the voice messages re-enter into the queue if there are multiple voice messages send at a stretch. At step 816, the first child 102 receives the voice message send by the parent mobile device 110.

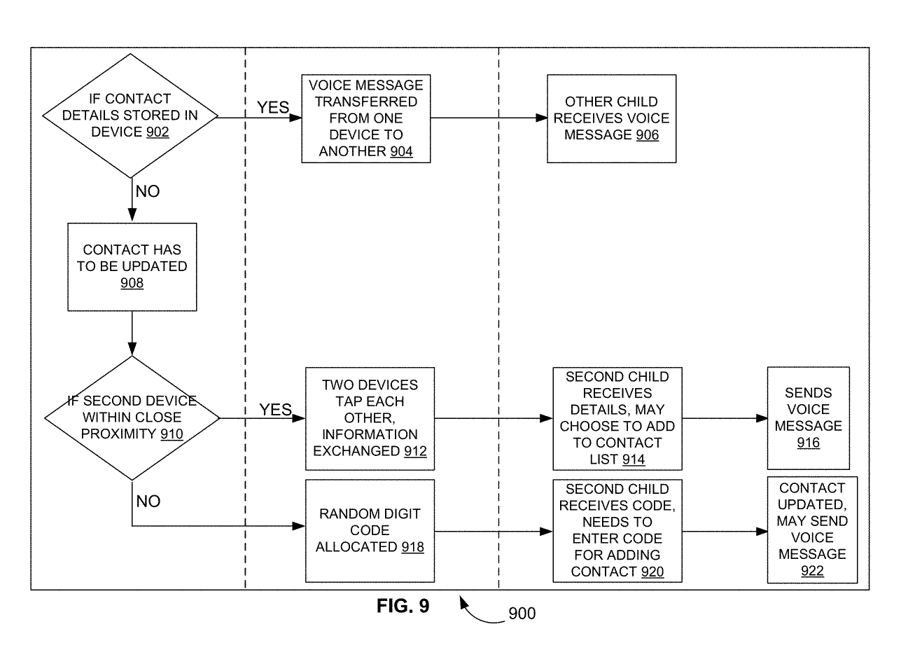

FIG. 9 is an interaction diagram 900 illustrating a process of the first child wearable device 104 connecting and communicating with the second child wearable device 114 of FIG. 1 according to an embodiment herein. At step 902, it is compulsory for the second child 116 to be in the first child wearable device 104 contact list, failing to which the child 102 will not be able to send a voice message. In one embodiment, if the second child 116 contact details are stored in the first child wearable device 104, then at step 904, the voice message is transferred from the first child wearable device 104 to the second child wearable device 114 with the help of the server 108. At step 906, the second child 116 receives the voice message. If the second child 116 is not stored in the first child wearable device 104, then at step 908, the contact has to be updated. At step 910, the first child wearable device 104 verifies whether the second child wearable device 114 is within the vicinity or at close proximity with the first child wearable device 104. In one embodiment, if the devices are at close proximity, then at step 912, the first child wearable device 104 taps the second child wearable device 114 and information is automatically exchanged by using the concept of NFC.

At step 914, the second child 116 receives the contact information, may browse through it, and then conclude whether to add the first child 102 as a contact or not. At step 916, the second child 116 may place a call to the child wearable device 104 once the contact details get updated in the second child wearable device 114. In another embodiment, if the devices are not within the vicinity and not at close proximity to each other. At step 918, the server 108 generates a random digit code (four digits) which will be sent to the second child wearable device 114 once the child 102 chooses to add the second child 116 as a friend. At step 920, the second child 116 receives the random digit code, and should enter the four digit code in the second child wearable 114 device if he/she wishes to add the first child 102 as a contact. The second child 116 only has up till five minutes to either accept or reject the friend request. After five minutes if the second child 116 does not reply, the first child 102 may re-send the friend request again. At step 922, the new contact gets updated on the first child wearable device 104, and the first child 102 may them choose to send a voice message to the second child 116.

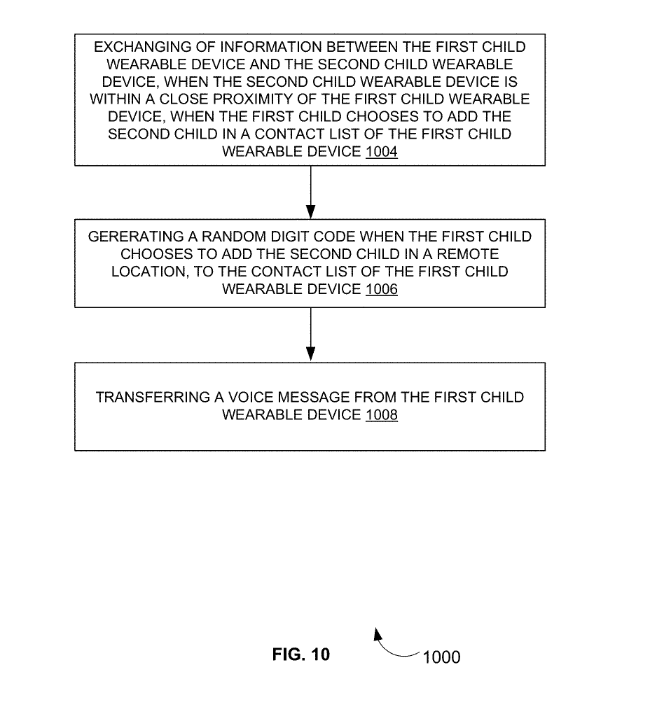

FIG. 10 is a flow diagram 1000 illustrating a communication between the first child wearable device 104 with the parent mobile device 110 and a second child wearable device 114 of FIG. 1 according to an embodiment herein. At step 1004, information is exchanged between the first child wearable device 104 and the second child wearable device 106, when the second child wearable device 114 is within a close proximity of the first child wearable device 104 when the first child 102 chooses to add the second child 116 to the contact list of the first child wearable device 104 The second child 116 associated with the second child wearable device 114 may view the information of the first child 102 associated with the first child wearable device 104 and choose to add the first child 102 to the contact list of the second child wearable device 114.

At step 1006, a random digit code (four digit code) is generated when the first child 102 chooses to add the second child 116 in a remote location, to the contact list of the first child wearable device 104. The second child 116 receives the random digit code on the second child wearable device 114 and has up till duration of five minutes to enter the random digit code stating that the second child 116 has acknowledged in adding the first child 102 to the contact list of the second child wearable device 114. At step 1008, the voice message of eight second duration is transferred from the first child wearable device 104 to at least one of (i) the second child wearable device 114 and (ii) the parent mobile device 110. Multiple voice messages may be sent at a stretch.

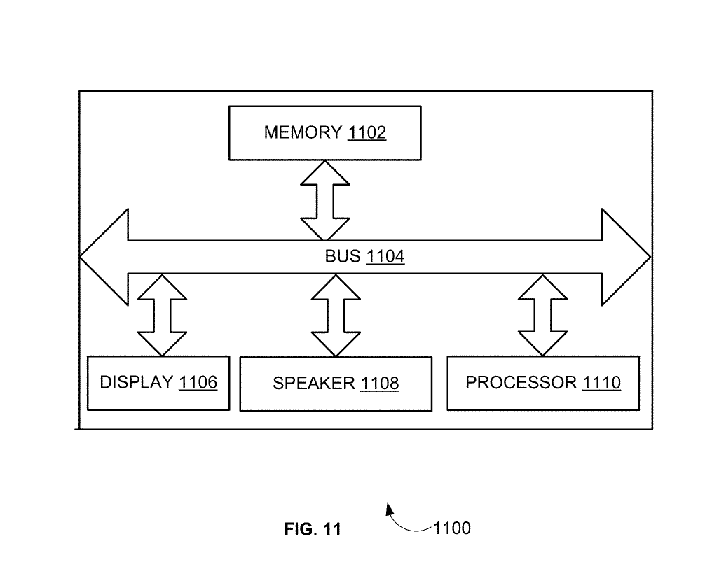

FIG. 11 illustrates an exploded view 1100 of the parent mobile device of FIG. 1 according to an embodiment herein. The exploded view 1100 includes a memory 1102 having a set of instructions, a bus 1104, a display 1106, a speaker 1108, and a processor 1110 capable of processing the set of instructions to perform any one or more of the methodologies herein, according to an embodiment herein. The processor 1110 may also enable digital content to be consumed in the form of video for output via one or more displays 1106 or audio for output via speaker and/or earphones 1108. The processor 1110 may also carry out the methods described herein and in accordance with the embodiments herein.

Digital content may also be stored in the memory 1102 for future processing or consumption. The memory 1102 may also store program specific information and/or service information (PSI/SI), including information about digital content (e.g., the detected information bits) available in the future or stored from the past. A user of the exploded 1100 may view this stored information on display 1106 and select an item of for viewing, listening, or other uses via input, which may take the form of keypad, scroll, or other input device(s) or combinations thereof. When digital content is selected, the processor 1110 may pass information. The content and PSI/SI may be passed among functions within the receiver using the bus 1104.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

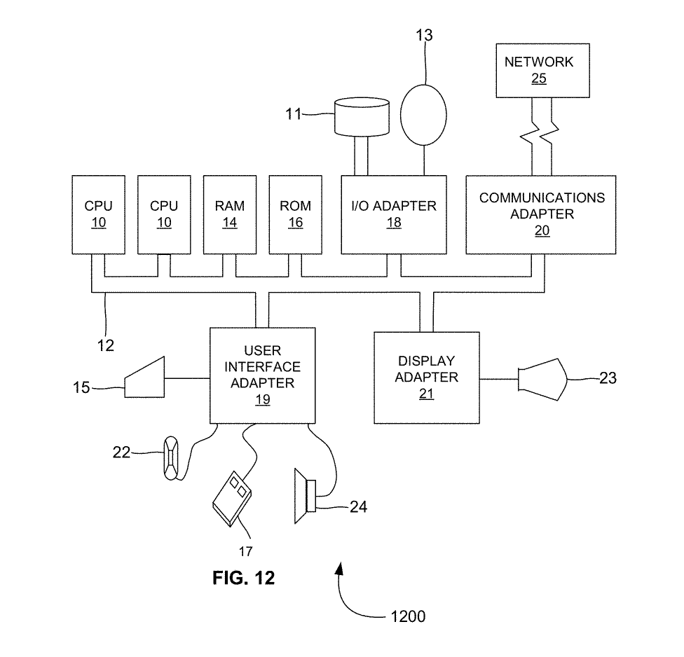

A representative hardware environment for practicing the embodiments herein is depicted in FIG. 12. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Reaching out for help during an emergency situation becomes easier for the primary emergency contact 114, secondary emergency contact 116, and the person in distress 102. Reaching out for help within the vicinity of the target registered user device 104 will alert the plurality of associated registered users, thus reducing the parents stress.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. One or more non-transitory computer readable storage mediums storing one or more sequences of instructions, which when executed by one or more processors, causes a first child associated with a first child wearable device to communicate with at least one of (i) a second child associated with a second child wearable device, and (i) a parent mobile device, said method comprising:
exchanging of information between said first child wearable device and said second child wearable device when said second child wearable device is within a close proximity of said first child wearable device, wherein said first child associated with said first child wearable device may view details of said second child associated with said second child wearable device and choose to add said second child in a contact list of said first child wearable device;
generating a random digit code when said second child wearable device is in a remote location to said first child wearable device, wherein said second child wearable device receives said random digit code and said second child has a threshold duration to enter said random digit code to acknowledge adding said first child in said contact list of said second child wearable device; and
transferring a voice message for said first child to communicate with from said first child wearable device to at least one of (i) said second child wearable device, and (ii) said parent mobile device.

2. The one or more non-transitory computer readable storage mediums storing one or more sequences of instructions of claim 1, wherein said voice message may only be transferred from said first child wearable device to said second child wearable device if said second child wearable device contact details are stored in said contact list of said first child wearable device.

3. A server enabling a first child associated with a first child wearable device to communicate with at least one of (i) a second child associated with a second child wearable device, and (ii) a parent mobile device, said server comprising:
a server memory that stores a voice message transfer database and a first set of modules, wherein said voice message transfer database stores contact information of persons associated with said first child wearable device; and
a server processor that executes said first set of modules, wherein said first set of modules comprising;
an information exchange module implemented by said server processor that transfers information between said first child wearable device and said second child wearable device, when said first child chooses to add said second child within a close proximity, to a contact list of said first child wearable device;
a digit code generation module implemented by said server processor that generates a random digit code, when said first child chooses to add said second child in a remote location, to said contact list of said first child wearable device; and
a voice message transfer module implemented by said server processor that transfers said voice message from said first child wearable device to at least one of (i) said second child wearable device and (ii) said parent mobile device.

4. A first child wearable device, wherein said first child wearable device comprising;
a device database that stores (i) information of all contacts stored in said first child wearable device and (ii) stores said voice messages received by said first child wearable device from at least one of (a) a second child wearable device and (b) a parent mobile device;
a voice message viewing module that enables a first child associated with said first child wearable device to view and listen to said voice messages received from at least one of (i) said second child wearable device and (ii) said parent mobile device;
a proximity contact updating module that enables said first child to view details of a second child associated with said second child wearable device and choose to add said second child in a contact list of said first child wearable device, when said first child wearable device is located within a close proximity of said second child wearable device;
a digit code receiving module that receives a random digit code by said second child associated with said second child wearable device, and said first child has a threshold duration to enter said random digit code to acknowledge adding said second child in said contact list of said first child wearable device, when said second child is in a remote location; and
an automatic message deletion module that automatically deletes heard voice messages and unheard voice messages from said first child wearable device within a threshold time period.

5. The first child wearable device of claim 4, further comprising a profile presentation module that presents a contact stored in said contact list of said first child wearable device by always showing a profile photo of said contact and at least one of (i) a name of said contact and (ii) a contact number of said contact.

6. The first child wearable device of claim 4, further comprising a pedometer module that updates a number of steps taken by said first child to a parent associated with said parent mobile device and if said first child is a pedometer champion, then said profile photo of said first child is embellished with a championship batch.

7. The first child wearable device of claim 6, wherein said championship batch embellished on said profile photo of said first child is viewed by at least one of (i) children in said contact list of said first child wearable device and (ii) other children registered within a server.

8. The first child wearable device of claim 4, wherein said server comprising;
a server memory that stores a voice message transfer database and a first set of modules, wherein said voice message transfer database stores contact information of persons associated with said first child wearable device; and
a server processor that executes said first set of modules, wherein said first set of modules comprising;
an information exchange module implemented by said server processor that transfers information between said first child wearable device and said second child wearable device, when said first child chooses to add said second child within a close proximity, to a contact list of said first child wearable device;
a digit code generation module implemented by said server processor that generates a random digit code, when said first child chooses to add said second child in a remote location, to said contact list of said first child wearable device; and
a voice message transfer module implemented by said server processor that transfers a voice message from said first child wearable device to at least one of (i) said second child wearable device and (ii) said parent mobile device.

9. The first child wearable device of claim 5, wherein said voice message is only transferred from said first child wearable device to said second child wearable device if said second child wearable device contact details are stored in said contact list of said first child wearable device.
